(19) United States
(12) Patent Application Publication
(10) Pub. No.: US 2010/0042847 A1
(43) Pub. Date: Feb. 18, 2010

(54) METHOD FOR AUTHENTICATION USING ONE-TIME IDENTIFICATION INFORMATION AND SYSTEM

(76) Inventors: Kwansoo JUNG, Daejeon-city (KR); Soohyung KIM, Daejeon-city (KR); Deokjin KIM, Daejeon-city (KR); Seunghun JIN, Daejeon-city (KR); Youngseob CHO, Daejeon-city (KR); Jinman CHO, Daejeon-city (KR); Sangrae CHO, Daejeon-city (KR); Daeseon CHOI, Daejeon-city (KR); Jonghyouk NOH, Daejeon-city (KR); Seunghyun KIM, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/498,417

(22) Filed: Jul. 7, 2009

(30) Foreign Application Priority Data
Aug. 18, 2008 (KR) 10-2008-0080439

(51) Int. Cl. G06F 21/00

(52) U.S. Cl. 713/183

(57) ABSTRACT

The present invention relates to a method and system that can safely and conveniently perform user authentication by a service provider server and at a public terminal using one-time identification information. According to the present invention, when user authentication is performed using a public terminal to receive an Internet service provided by a service provider, personal identity information to be provided to the service provider can be prevented from being leaked due to fishing or hacking while the personal identity information is input. Therefore, the user can be safely and conveniently authenticated by the service provider.

### RELATED APPLICATIONS

The present application claims priority to Korean Patent Application Serial Number 10-2008-0080439, filed on Aug. 18, 2008, the entirety of which is hereby incorporated by reference.

### BACKGROUND OF THE INVENTION

1. Technical Field

The present invention relates to a user authentication method and system using one-time identification information, and more particularly, to a method and system that can safely and conveniently perform user authentication by a service provider server at a public terminal using one-time identification information.

2. Description of the Related Art

In recent years, users use various types of Internet access tools to use Internet services. The Internet utilization using mobile terminals (for example, cellular phones or PDAs) as well as personal computers installed in the home or company of the users has explosively increased.

However, in order to receive a service from a service provider, a user needs to memorize Web sites that the user joins, along with user IDs and passwords that the user is required to register when joining the Web sites. For this reason, the user generally registers onto the Web sites using the same user ID and password, which causes a problem. If the user uses the same ID and password for the Web sites, personal information of the user may be easily plagiarized online. For example, when personal information is leaked on a specific Web site, the leaked personal information may be illegally used on other Web sites. Due to this, the user may suffer unexpected problems.

Meanwhile, a public terminal (for example, a public computer that is installed in an Internet cafe or a public place) is often used when high computing power and a high-definition display are needed in a public place. However, since there are many weak points in security, especially in the case of a public place, there are more opportunities of personal information of the user (for example, user ID and password) being leaked due to fishing or hacking, while the user inputs the personal information to the public terminal to receive an Internet service from a service provider using the public terminal.

In order to resolve these problems, the following methods have been suggested. For example, a Web browser automatically inputs a previously input password or when a user uses a public terminal, a one-time authentication code is transmitted to a mobile terminal and the user is authenticated using the transmitted authentication code. However, the above-described methods cannot fundamentally solve the above-described problems.

According to another method, authentication information (for example, a URL or password of a server) is stored in a physical security medium, such as a smart card, thereby enabling various types of personal terminals to have access to the server. However, according to this method, an additional hardware device is usually needed to be installed or the authentication information may be leaked at a public terminal.

### SUMMARY OF THE INVENTION

Accordingly, the present invention has been made to solve the above-described problems, and it is an object of the present invention to provide a user authentication method and system that can safely and conveniently perform user authentication using a portable terminal without leaking personal information of a user, when user authentication is performed to use an Internet service at a public terminal installed in a public place.

A user authentication method according to the present invention using one-time identification information is a user authentication method that performs user authentication by a service provider server using one-time identification information. In this case, a portable terminal can have access to the service provider server. The user authentication method includes a step of allowing the portable terminal to have access to the service provider server to perform user authentication; a step of allowing the portable terminal to generate a one-time password and transmit the one-time password to the service provider server; a step of allowing the portable terminal to receive a one-time identifier from the service provider server; and a step of allowing the portable terminal to display the one-time password and the one-time identifier.

In the step of allowing the portable terminal to have access to the service provider server to perform user authentication, the portable terminal may hold an identity of a user and perform user authentication by the service provider server using the identity.

In the step of allowing the portable terminal to transmit the one-time password to the service provider server, the portable terminal may encrypt the one-time password using an authentication key or a session key induced by the authentication key and transmits the encrypted one-time password to the service provider server.

Further, a user authentication method according to the present invention using one-time identification information is a user authentication method that performs user authentication by a service provider server using one-time identification information. The user authentication method includes a step of allowing the service provider server to authenticate a user of a portable terminal in accordance with a user authentication request from the portable terminal; a step of allowing the service provider server to receive a one-time password from the portable terminal; a step of allowing the service provider server to store the one-time password and identification information of the user; a step of allowing the service provider server to generate a one-time identifier, store the one-time identifier and the identification information of the user, and set an effective time of the one-time identifier; and a step of allowing the service provider server to transmit the one-time identifier and the effective time data to the portable terminal.

In the step of allowing the service provider server to transmit the one-time identifier to the portable terminal, the service provider server may encrypt the one-time identifier and the effective time data using an authentication key or a session key induced by the authentication key and transmits the encrypted one-time identifier and effective time data to the portable terminal.

The user authentication method may further include, when an authentication request using the one-time identifier and the one-time password is received from a public terminal within the effective time, a step of allowing the service provider server to approve access of the public terminal and report an access approval breakdown of the public terminal to the portable terminal.

The user authentication method may further include, when an authentication request using the one-time identifier and the one-time password is received from a public terminal within the effective time, a step of allowing the service provider server to approve access of the public terminal and discard the one-time identifier and the one-time password.

The user authentication method may further include, when an authentication request using the one-time identifier and the one-time password is not received from a public terminal within the effective time, a step of allowing the service provider server to discard the one-time identifier and the one-time password.

The user authentication method may further include a step of allowing the service provider server to discard the stored one-time identifier and one-time password in accordance with a one-time authentication information discard request from a user terminal.

Furthermore, a portable terminal according to the present invention is a portable terminal that is a terminal of a user authentication system using one-time identification information. The portable terminal includes an authentication unit that performs user authentication by a service provider server; an authentication supporting unit that generates a one-time password; a communication unit that transmits the one-time password to the service provider server and receives an one-time identifier from the service provider server; and an interaction unit that displays the one-time password and the one-time identifier to a user.

The authentication supporting unit may encrypt the one-time password using an authentication key or a session key induced by the authentication key.

Furthermore, a service provider server according to the present invention is a service provider server of a user authentication system using one-time identification information. The service provider server includes a user authenticating unit that authenticates a user of a portable terminal in accordance with a user authentication request from the portable terminal; a user authentication supporting unit that stores a one-time password received from the portable terminal and identification information of the user, generates a one-time identifier and stores the one-time identifier and the identification information of the user, and sets an effective time of the one-time identifier; and a communication unit that transmits the one-time identifier the effective time data to the portable terminal.

The user authentication supporting unit may encrypt the one-time identifier and the effective time data using an authentication key or a session key induced by the authentication key.

The user authenticating unit may approve access of a public terminal and report an access approval breakdown of the public terminal to the portable terminal, when an authentication request using the one-time identifier and the one-time password is received from the public terminal within the effective time.

The user authentication supporting unit may discard the stored one-time identifier and one-time password in accordance with a one-time authentication information discard request from a user terminal.

According to the present invention, the following effects can be achieved.

When user authentication is performed at a public terminal to receive an Internet service provided by a service provider, personal identity information to be provided to the service provider can be prevented from being leaked due to fishing or hacking while the personal identity information is input. Therefore, the user can be safely and conveniently authenticated by the service provider.

Further, since the user does not need to memorize an ID and a password to use an Internet service, it is possible to prevent personal information from being easily plagiarized online, which occurs when the user uses the same user ID and password at a plurality of Web sites for convenience of utilization.

Furthermore, when user authentication is performed to receive an Internet service provided by the service provider, the service provider does not need to install an additional physical device, such as a one-time information authentication server. Even when the user does not have a physical security medium such as a smart card where authentication information of the user is stored, if the user installs a simple application program in a portable terminal, it is possible to simply and conveniently perform user authentication.

### BRIEF DESCRIPTION OF THE DRAWINGS

FIG. 1 is a schematic diagram illustrating the structure of a user authentication system according to an embodiment of the present invention.

FIG. 2 is a diagram specifically illustrating a portable terminal and a service provider server shown in FIG. 1.

FIG. 3 is a diagram illustrating a series of operations that are performed by a portable terminal to implement a user authentication method according to an embodiment of the present invention.

FIG. 4 is a diagram illustrating a series of operations that are performed by a service provider server to implement a user authentication method according to an embodiment of the present invention.

### DESCRIPTION OF THE PREFERRED EMBODIMENTS

The present invention will be described in detail with reference to the accompanying drawings. In this case, a repetitive description, and a detailed description of known functions and structures that may make the subject matter of the present invention unclear will be omitted. Rather, these embodiments are provided so that this disclosure will be thorough and complete and will fully convey the concept of the present invention to those skilled in the art. In addition, in each drawing, the size of each layer and region and relative sizes can be exaggerated for clarification.

Hereinafter, a preferred embodiment of the present invention will be described in detail with reference to the accompanying drawings.

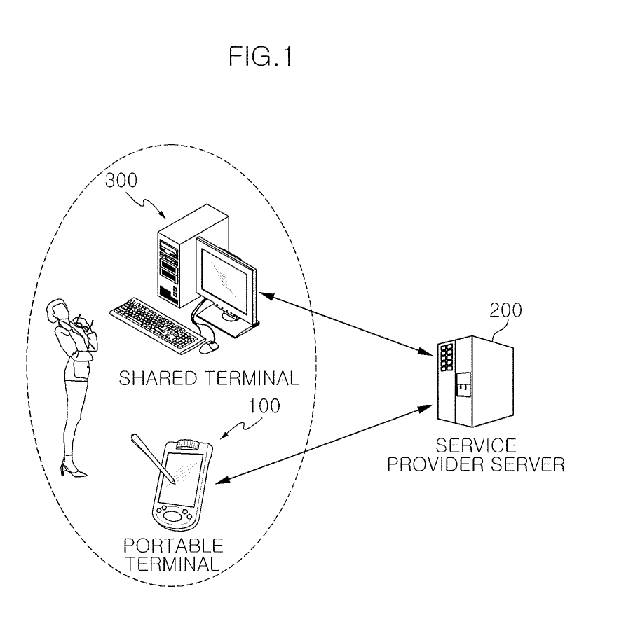

FIG. 1 is a schematic view illustrating the structure of a user authentication system according to an embodiment of the present invention.

A user authentication method and system using a portable terminal according to an embodiment of the present invention includes a portable terminal 100, a service provider server 200, and a public terminal 300.

The portable terminal 100 is a personal Internet access tool in which a user can always hold without depending on the time and place and safely keep personal information. For example, the portable terminal 100 may be a personal Internet access tool, such as a personal mobile phone, a PDA, and a Wibro phone. The portable terminal 100 supports an authentication system that enables the user to use the public terminal 300 to perform user authentication by the service provider server 200.

The service provider server 200 is a service provider device that provides an Internet service to a user who uses an Internet access tool, such as a mobile terminal, a desktop computer, or a note-book computer. For example, the service provider server 200 may be an Internet portal service server, a game service server, and a shopping service server. The service provider server 200 provides registration and authentication services through the portable terminal 100.

The public terminal 300 is a public Internet access tool, such as a desk-top computer or a note-book computer, which is included in Internet cafes or public places that people have access.

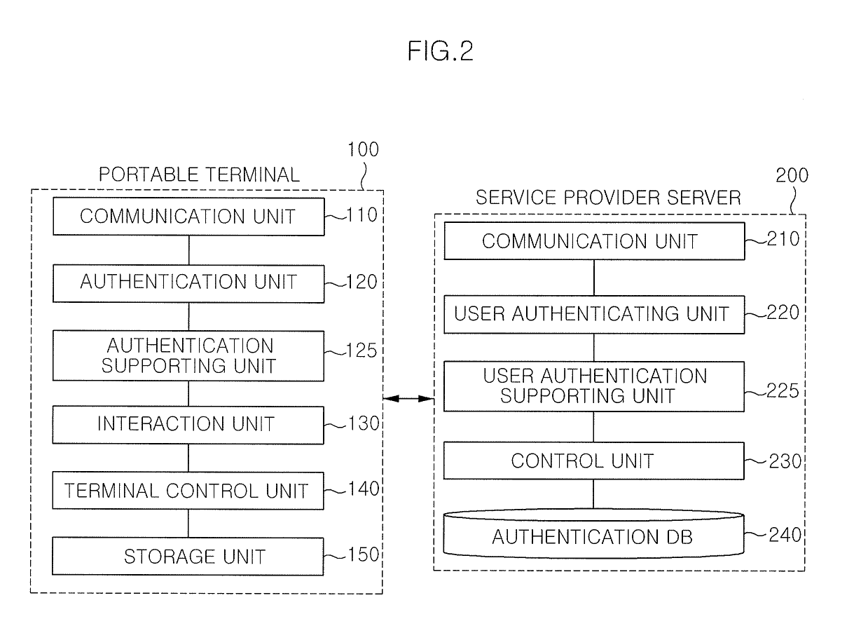

FIG. 2 is a diagram specifically illustrating the portable terminal 100 and the service provider server 200 shown in FIG. 1, which allows a user to use a portable terminal to be safely and conveniently authenticated by a service provider server at a public terminal.

The portable terminal 100 according to the present invention includes a communication unit 110 that is used to communicate with the service provider server 200, an authentication unit 120 that performs user authentication by the service provider server 200, an authentication supporting unit 125 that allows a user to use one-time identification information to perform user authentication at the public terminal 300, an interaction unit 130 that the user uses to input a command and confirm a corresponding screen, a terminal control unit 140 that controls the portable terminal 100, and a storage unit 150 that stores a basic application and data needed to implement the present invention. In this case, the application may be software that is used to provide services or resources, which are provided from the service provider server 200 connected to the portable terminal 100 by a network, to the user. For example, the application may be a Browser.

The service provider server 200 according to the present invention includes a communication unit 210 that is used to communicate with the portable terminal 100, a user authenticating unit 220 that authenticates a user of the portable terminal 100, a user authentication supporting unit 220 that allows a user to use one-time identification information to perform user authentication at the public terminal 300, a control unit 230 that controls the service provider server 200, and an authentication DB 240 that stores information needed to perform user authentication.

The authentication unit 120 of the portable terminal 100 has access to the service provider server 200 and uses an authentication protocol to perform user authentication. As a method in which user authentication is performed in the authentication unit 120, various methods may be applied. Preferably, a user authentication method using a digital identity (ID) wallet is applied. The digital ID wallet is called by a Web application of the portable terminal 100, and performs a Website participation process that is needed to receive a predetermined Internet service from the service provider server 200 and a Website withdrawal process. The digital ID wallet holds an identity of the user. In general, the identity is information that indicates characteristics of each person. Specifically, the identity indicates user information, such as a company address, a home address, a telephone number, and a family, which are issued by or registered in a government or company, an educational background, a hobby, and a religion. The identity is information that can uniquely discriminate individual persons. The authentication unit 120 performs a process such that the service provider server 200, which requests to transmit the identity of the user, can share the corresponding identity. The authentication unit 120 interacts with the user authenticating unit 220 of the service provider server 200 to perform user authentication.

If user authentication is completed between the portable terminal 100 and the service provider server 200 through the authentication unit 120, the authentication supporting unit 125 performs a series of processes such that a user can safely and conveniently perform user authentication at a public terminal. Specifically, the authentication supporting unit 125 generates a one-time password (OTP) that is needed to perform user authentication at the public terminal. At this time, the authentication supporting unit 125 may directly receive a one-time password from a user through the interaction unit 130. The authentication supporting unit 125 encrypts the one-time password and transmits the encrypted one-time password to the service provider server 200 through the communication unit 110, and requests the service provider server 200 to transmit a one-time identifier (OTID). At this time, the one-time identifier means a one-time identifier that is used when a user uses the portable terminal 100 to perform user authentication at the public terminal. As a method that is used to encrypt and transmit a one-time password, various methods may be applied. For example, the authentication supporting unit 125 of the portable terminal 100 may exchange an authentication key with the service provider server 200, and use the exchanged authentication key or a session key induced by the authentication key to encrypt a one-time password. In this case, a mechanism that is used to exchange the authentication key is not limited to a specific mechanism. For example, if a secret value generated by the portable terminal 100 is encrypted using a public key of the service provider server 200 and transmitted to the service provider server 200, the service provider server 200 decrypts the secret value using its personal key. As a result, the portable terminal 100 and the service provider server 200 can exchange the authentication key with each other.

Meanwhile, the user authentication supporting unit 225 of the service provider server 200 receives the encrypted one-time password and a one-time identifier request transmitted from the portable terminal 100 through the communication unit 210. The user authentication supporting unit 225 decrypts the encrypted one-time password that is received from the portable terminal 100, matches the one-time password to the user identification information acquired by the above-described user authentication process, and stores and manages the matched result in the authentication DB 240. The user authentication supporting unit 225 generates a one-time identifier in accordance with the one-time identifier request from the portable terminal 100, and sets an effective time for the generated one-time identifier. In this case, the effective time means time during which the user can effectively perform user authentication at the public terminal using the one-time identifier. The user authentication supporting unit 225 matches the one-time identifier generated in accordance with the one-time identifier request from the portable terminal 100 to the user identification information and stores and manages the matched result in the authentication DB 240. The user authentication supporting unit 225 encrypts the generated one-time identifier and the effective time data and transmits the one-time identifier and the effective time data to the portable terminal 100 through the communication unit 210. At this time, the user authentication supporting unit 225 may use the authentication key or the session key exchanged with the portable terminal 100 to encrypt the one-time identifier and the effective time data.

The communication unit 110 of the portable terminal 100 receives the one-time identifier and the effective time data transmitted from the service provider server 200 and transmits the one-time identifier and the effective time data to the authentication supporting unit 125. The authentication supporting unit 125 decrypts the received one-time identifier and effective time data and transmits the one-time identifier and the effective time data to the terminal control unit 140. The terminal control unit 140 allows the one-time identifier and the effective time transmitted from the authentication supporting unit 125 and the generated one-time password to be displayed through the interaction unit 130. The user uses the one-time password and the one-time identifier displayed through the interaction unit 130 to perform user authentication at the public terminal.

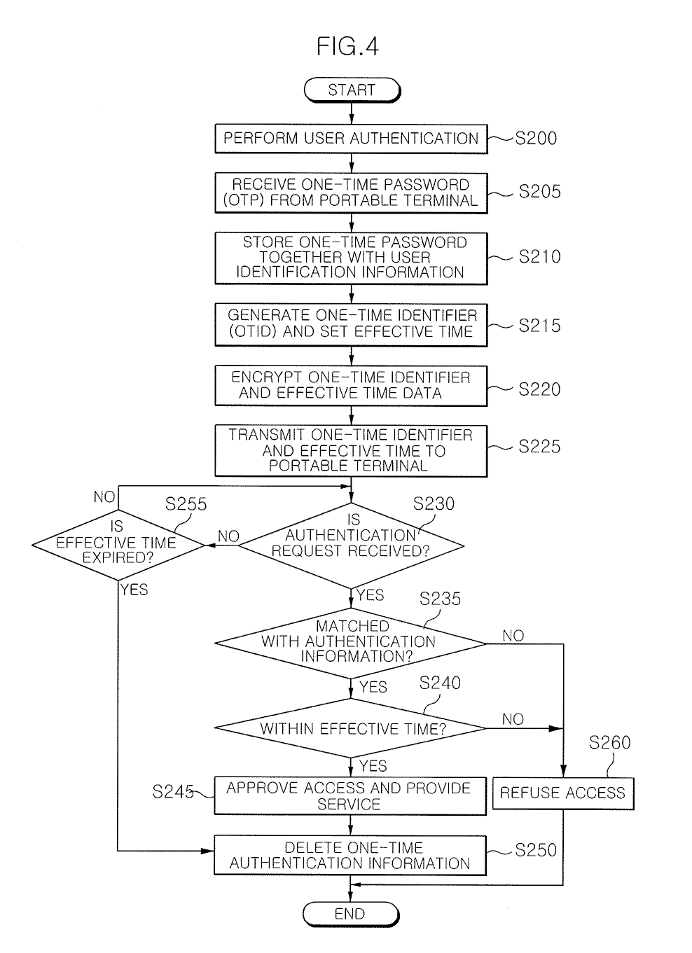

Meanwhile, the user authenticating unit 220 of the service provider server 200 verifies the one-time identifier and the one-time password input from the user to perform user authentication. The service provider server 200 approves access based on only the verified user and provides a service to the verified user, which will be described in detail below with reference to FIG. 4.

As described above, according to the present invention, the user authentication can be performed at the public terminal using the one-time identifier provided by the server provider server and the one-time password generated by the portable terminal, thereby preventing identity information of a user from being leaked due to fishing or hacking while the user inputs his/her identity information at the public terminal. Even if the identity information of the user is leaked, the identity information is one-time identification information from which the identity of the user cannot be recognized, and thus there is no possibility where the privacy of the user is trespassed. Accordingly, according to the present invention, the user can use the portable terminal to safely and conveniently perform user authentication at the public terminal.

Further, the user does not need to memorize and write user's ID and password in order to use an Internet service. As a result, it is possible to prevent personal information from being easily plagiarized on-line, which occurs when the user uses the same user ID and password at a plurality of Web sites for convenience.

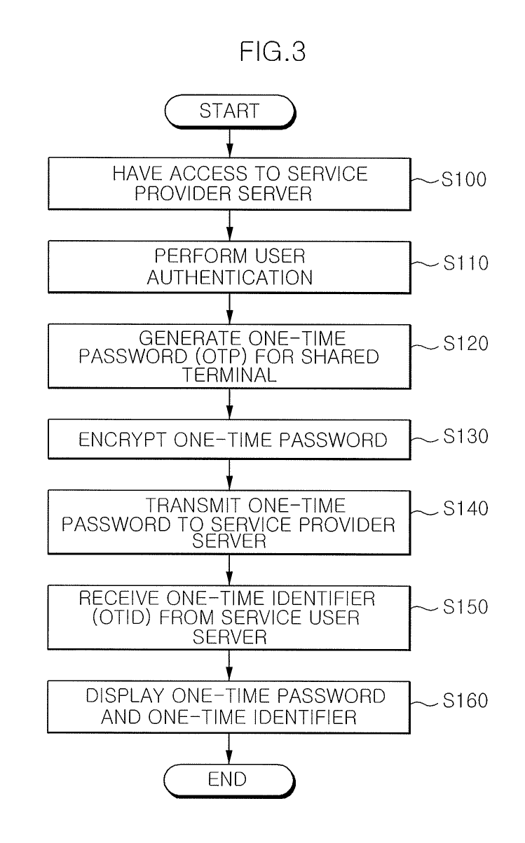

FIG. 3 is a diagram illustrating a series of operations that are performed in a portable terminal in order to implement a user authentication method according to an embodiment of the present invention.

First, the portable terminal 100 has access to the service provider server 200 and uses an authentication protocol to perform user authentication (S100 and S110). As described above, as a method that is used to perform user authentication, various methods may be applied. However, it is preferable that user authentication be performed using a digital ID wallet. If user authentication is completed between the portable terminal 100 and the service provider server 200, the portable terminal 100 generates a one-time password (OTP) that is needed to perform user authentication at the public terminal 300 (S120).

Next, the portable terminal 100 encrypts the one-time password generated in Step S120 and transmits the encrypted one-time password to the service provider server 200 through the communication unit 110, and requests the service provider server 200 to transmit a one-time identifier (OTID) (S130 and S140).

Next, the portable terminal 100 receives the encrypted one-time identifier and effective time data transmitted from the service provider server 200. The portable terminal 100 decrypts the received one-time identifier and effective time data and allows the interaction unit 130 to display the one-time identifier, the effective time data, and the one-time password generated in Step S120 to the user (S160) The user can use the one-time password and the one-time identifier displayed through the interaction unit 130 to perform user authentication at the public terminal 300.

FIG. 4 is a diagram illustrating a series of operations that are performed in a service provider server in order to implement a user authentication method according to an embodiment of the present invention.

The service provider server 200 performs a process such that an identity of the user is public between the service provider server 200 and the portable terminal 100 using an authentication protocol. The service provider server 200 interacts with the portable terminal 100 to perform user authentication (S200).

After the user authentication is performed, the service provider server 200 receives the encrypted one-time password and a one-time identifier request from the portable terminal 100 (S205). After receiving the encrypted one-time password and the one-time identifier request, the service provider server 200 decrypts the encrypted one-time password, matches the one-time password and the user identification information acquired by Step S200 to each other, and stores and manages the matched result (S210).

Next, the service provider server 200 generates a one-time identifier in accordance with the one-time identifier request from the portable terminal 100, and sets an effective time for the generated one-time identifier (S215). The service provider server 200 matches the one-time identifier, which is generated in accordance with the one-time identifier request from the portable terminal 100, to the user identification information and stores and manages the matched result.

After Step S215, the service provider server 200 encrypts the generated one-time identifier and the effective time data and transmits the one-time identifier and the effective time data to the portable terminal 100. The service provider server 200 determines whether a user authentication request is received from the public terminal 300 (S230). That is, the service provider server 200 determines whether the user uses the one-time identifier generated by the service provider server 200 and the one-time password generated by the portable terminal 100 to have access to the service provider server 200 and request user authentication (S230).

As the determined result of Step S230, when the public terminal 300 requests the service provider server 200 to perform user authentication, that is, when the user uses the portable terminal 100 to confirm the one-time identifier and the one-time password (hereinafter, referred to as one-time identification information), transmits the one-time identification information from the public terminal 300 to the service provider server 200, and requests the service provider server 200 to perform user authentication, the service provider server 200 determines whether the one-time identification information transmitted from the public terminal 300 is matched to one-time authentication information (one-time identification information) stored in the authentication DB (S235).

As the determined result of Step S235, when the one-time identification information input from the public terminal 300 is matched to the one-time authentication information stored in the service provider server 200, the service provider server 200 determines whether the user authentication request from the public terminal 300 is made within the set effective time (S240). For example, if the effective time of the corresponding one-time identification information is 3 minutes, in order to receive a normal service from the service provider server 200, the public terminal needs to use the one-time identification information to request the service provider server 200 to perform user authentication within 3 minutes after the one-time identification information is received from the service provider server 200.

As the determined result of Step S240, when the user authentication request is made within the effective time, the service provider server 200 approves access of the corresponding public terminal 300 and provides a normal service. Then, the service provider server 200 reports an access approval breakdown of the public terminal 300 to the portable terminal 100. Accordingly, the user can monitor his/her service utilization breakdown through the access approval breakdown transmitted from the service provider server 200 in real time, thereby reinforcing security of personal information. After approving access of the corresponding public terminal 300 and providing a normal service, the service provider server 200 deletes the one-time authentication information of the corresponding user that is stored in the authentication DB.

Meanwhile, when the authentication request from the public terminal 300 is not received within the effective time in Step S230, the service provider server 200 proceeds to Step S250, deletes the one-time authentication information of the corresponding user stored in the authentication DB, and ends the process. As a result, it is possible to minimize the leakage of personal information of a user that may occur due to the leakage of the one-time identification information while the user performs the user authentication using the one-time identification information at the public terminal 300.

When it is determined that the one-time identification information received from the public terminal 300 is not matched to the one-time authentication information stored in the service provider server 200 in Step S235 or the one-time identification information input from the public terminal 300 is received exceeding the corresponding effective time, the service provider server 200 refuses access of the public terminal 300 and ends the process.

Meanwhile, when the user desires to delete the one-time authentication information that is stored in the service provider server 200, the user uses a terminal that can securely have access to the service provider server 200 and has access to the service provider server 200 to perform a user authentication process. Then, the user may request the service provider server 200 to discard his/her one-time authentication information, such that his/her one-time authentication information stored in the authentication DB is discarded. As a result, when the user lost his/her portable terminal, it is possible to discard the one-time authentication information registered in the service provider server. It is possible to remove the possibility that another person will acquire the portable terminal of the user where the one-time identification information is stored and illegally use the one-time identification information.

The present invention can be implemented as codes, which can be read by a computer and stored in a recording medium readable by the computer. Examples of the recording medium that can be read by the computer include all kinds of recording devices where data readable by a computer system is stored. Specifically, examples of the recording medium that can be read by the computer may include a ROM, a RAM, a CD-ROM, a magnetic tape, a floppy disk, and an optical data storage device. The recording medium may be implemented in a form of a carrier wave (for example, transmission through the Internet). In the recording medium that can be read by the computer, codes can be stored and executed, which are distributed to a system connected through a network and can be read by the computer in a distribution method.

The optimal embodiments have been disclosed in the drawings and the specification. The specific terminologies used herein are for the purpose of describing the present invention only and are not intended to be limiting of the present invention described in the appended claims. Accordingly, it will be apparent to those skilled in the art that various modifications and changes may be made without departing from the scope and spirit of the invention. The scope of the present invention should be defined by the technical spirit of the appended claims rather than by the above description.

What is claimed is:

1. A user authentication method that performs user authentication by a service provider server using one-time identification information, a portable terminal having access to the service provider server, the user authentication method comprising:
a step of allowing the portable terminal to have access to the service provider server to perform user authentication;
a step of allowing the portable terminal to generate a one-time password and transmit the one-time password to the service provider server;
a step of allowing the portable terminal to receive a one-time identifier from the service provider server; and
a step of allowing the portable terminal to display the one-time password and the one-time identifier.

2. The user authentication method of claim 1,
wherein, in the step of allowing the portable terminal to have access to the service provider server to perform user authentication,
the portable terminal holds an identity of a user and performs user authentication by the service provider server using the identity.

3. The user authentication method of claim 1,
wherein, in the step of allowing the portable terminal to transmit the one-time password to the service provider server,
the portable terminal encrypts the one-time password using an authentication key or a session key induced by the authentication key and transmits the encrypted one-time password to the service provider server.

4. A user authentication method that performs user authentication by a service provider server using one-time identification information, the user authentication method comprising:
a step of allowing the service provider server to authenticate a user of a portable terminal in accordance with a user authentication request from the portable terminal;
a step of allowing the service provider server to receive a one-time password from the portable terminal;
a step of allowing the service provider server to store the one-time password and identification information of the user;
a step of allowing the service provider server to generate a one-time identifier, store the one-time identifier and the identification information of the user, and set an effective time of the one-time identifier; and
a step of allowing the service provider server to transmit the one-time identifier to the portable terminal.

5. The user authentication method of claim 4,
wherein, in the step of allowing the service provider server to transmit the one-time identifier to the portable terminal,
the service provider server encrypts the one-time identifier using an authentication key or a session key induced by the authentication key and transmits the encrypted one-time identifier to the portable terminal.

6. The user authentication method of claim 4, further comprising:
when an authentication request using the one-time identifier and the one-time password is received from a public terminal within the effective time,
a step of allowing the service provider server to approve access of the public terminal and report an access approval breakdown of the public terminal to the portable terminal.

7. The user authentication method of claim 4, further comprising:
when an authentication request using the one-time identifier and the one-time password is received from a public terminal within the effective time,
a step of allowing the service provider server to approve access of the public terminal and discard the one-time identifier and the one-time password.

8. The user authentication method of claim 4, further comprising:
when an authentication request using the one-time identifier and the one-time password is not received from a public terminal within the effective time,
a step of allowing the service provider server to discard the one-time identifier and the one-time password.

9. The user authentication method of claim 4, further comprising:
a step of allowing the service provider server to discard the stored one-time identifier and one-time password in accordance with a one-time authentication information discard request from a user terminal.

10. A portable terminal that is a terminal of a user authentication system using one-time identification information, the portable terminal comprising:
an authentication unit that performs user authentication by a service provider server;
an authentication supporting unit that generates a one-time password;
a communication unit that transmits the one-time password to the service provider server and receives an one-time identifier from the service provider server; and
an interaction unit that displays the one-time password and the one-time identifier to a user.

11. The portable terminal of claim 10,
wherein the authentication supporting unit encrypts the one-time password using an authentication key or a session key induced by the authentication key.

12. A service provider server of a user authentication system using one-time identification information, comprising:
a user authenticating unit that authenticates a user of a portable terminal in accordance with a user authentication request from the portable terminal;
a user authentication supporting unit that stores a one-time password received from the portable terminal and identification information of the user, generates a one-time identifier and stores the one-time identifier and the identification information of the user, and sets an effective time of the one-time identifier; and
a communication unit that transmits the one-time identifier to the portable terminal.

13. The service provider server of claim 12,
wherein the user authentication supporting unit encrypts the one-time identifier using an authentication key or a session key induced by the authentication key.

14. The service provider server of claim 12,
wherein the user authenticating unit approves access of a public terminal and reports an access approval breakdown of the public terminal to the portable terminal, when an authentication request using the one-time identifier and the one-time password is received from the public terminal within the effective time.

15. The service provider server of claim 12,
wherein the user authentication supporting unit discards the stored one-time identifier and one-time password in accordance with a one-time authentication information discard request from a user terminal.
